(19) United States
(12) Patent Application Publication
(10) Pub. No.: US 2015/0185168 A1
(43) Pub. Date: Jul. 2, 2015

(54) DEVICE FOR MEASURING RESONANT INELASTIC X-RAY SCATTERING OF A SAMPLE

(71) Applicant: Helmholtz-Zentrum Berlin fuer Materialien und Energie GmbH, Berlin (DE)

(72) Inventors: Alexei Erko, Berlin (DE); Alexander Foehlisch, Berlin (DE); Jens Konstantin Rehanek, Berlin (DE); Christian Schuessler-Langeheine, Berlin (DE)

(21) Appl. No.: 14/412,461

(22) PCT Filed: Jul. 3, 2013
(86) PCT No.: PCT/DE2013/100245

§ 371 Date: Jan. 2, 2015

(30) Foreign Application Priority Data
Jul. 5, 2012 (DE) 10 2012 013 530.0

(51) Int. Cl. G01N 23/20

(52) U.S. Cl. CPC G01N 23/20066

(57) ABSTRACT

A device for measuring resonant inelastic X-ray scattering of a sample with a single exposure step includes a first reflection zone plate configured to be irradiated first and foremost by an X-ray beam. The device also includes a sample arranged at the focus of the diffracted radiation from the first reflection zone plate. The device additionally includes a second reflection zone plate arranged at a distance of its focal length from the sample. The device further includes a detector arranged at the focal plane of the diffracted radiation of the second reflection zone plate and configured to perform spatially-resolved two-dimensional detection. The reflection zone plates are arranged cross-dispersively. The wavelength ranges of the reflection zone plates are tuned to one another corresponding to an absorption edge of an element of the sample.

### CROSS REFERENCE TO RELATED APPLICATION

This application is a U.S. National Phase application under 35 U.S.C. §371 of International Application No. PCT/DE2013/100245 (WO 2014/005579 A1), filed on Jul. 3, 2013, and claims benefit to German Patent Application No. DE 10 2012 013 530.0, filed Jul. 5, 2012.

### FIELD

The invention relates to a device for the measurement of resonant inelastic X-ray scattering of a sample in the soft and hard regions of X-ray radiation with a single exposure step.

### BACKGROUND

Resonant Inelastic X-ray Scattering (RIXS) is a method in which the interaction of matter is used with X-ray radiation to determine electronic states in the material that is being examined

Inelastically scattered radiation is produced by processes in which the exiting radiation is converted into energy and momentum with respect to the incident radiation by the interaction of the X-ray radiation with matter.

In RIXS, the energies and momenta transferred by the incident X-ray radiation are transmitted to electrons in near-core orbitals (states), and this causes them to become excited to higher energy states. As a result of this excitation, electrons make transitions from higher orbitals to fill the orbitals close to the core, which are now not fully occupied. In the process, radiation is emitted, scattered radiation, and the differences between the scattered radiation and the incident radiation provide information about the energetic states and possible transitions of electrons in the material.

RIXS is therefore a useful tool for characterizing occupied and free electronic states as well as lattice vibrations in a material. In addition, measurements can be taken depending on the polarization of the incident X-ray radiation, so that information about the symmetry of the transitions of electrons can also be obtained.

RIXS is a resonant method, since the energy of the incident radiation corresponds to that of an absorption edge of an element in the material under examination. Consequently, RIXS is also an element-specific method.

Since it uses X-rays, RIXS is useful for examining the volume of the material to be tested (sample) on the basis of the interaction cross section of the X-ray radiation with the matter, not just the material surface.

The spectrum of the radiation used for RIXS ranges from energies in the range from ˜0.001 keV (soft radiation) up to X-ray radiation energies of 115 keV (hard radiation). In the following text in this document, the entire range of radiation used for RIXS will be treated as being associated with X-ray radiation.

In order to conduct RIXS, synchrotron radiation is needed because of the necessary tunability of the incident radiation and the intensity required to obtain a suitable yield of scattered radiation.

In order to conduct analyses with RIXS, a number of instrumental conditions must be met. Some of these have to do with the provision of the beam incident on the sample. Others are concerned with the spectrometer that analyses the scattered radiation from the material being tested (sample) for a change in energy and possibly momentum compared with the incident radiation.

The energy of the incident beam must be adjustable in the range of an absorption edge of an element that is to be examined Various monochromators are used for this. Arrays of crystal monochromators are suitable for generating monochromatic radiation with low bandwidth (spectral width) at angles predetermined by the crystal structure. In order to investigate the dependence of the scattered radiation on the energy or wavelength of the incident radiation, the angle between the monochromators and the X-ray beam is altered incrementally.

Diffraction lattices or other suitable means are used to separate and disperse the radiation spatially in a wavelength range from a few meV to eV corresponding to the lattice intervals. This wavelength range is then mapped separately and linearly in the dispersion direction on the sample.

The terms energy-dispersive and wavelength-dispersive methods both appear in the technical literature. The term energy-dispersive is used most often for methods in which the intensity of a particular X-ray radiation energy is determined with semiconductor detectors. No local/spatial separation (dispersion) of energies takes place. On the other hand, the term wavelength-dispersive refers precisely to methods in which spatial separation of the wavelengths does take place. In the following, all data refers to wavelength-dispersive methods, which cause a spatial separation of the wavelengths (energies), although occasionally information is given about the radiation in energy units.

In the beam path in front of the sample, the incident X-ray beam may also be focused on the sample by one or more suitable means, such as focusing mirrors and slots, and trimmed to minimise the volume that needs to be tested, to maximise the intensity of radiation on the sample, and to improve the resolution.

The spectrometer measures the intensity of the scattered radiation depending on the energy or wavelength of the radiation that is incident on the sample, and optionally depending on the angle of incidence or reflection. For this too, diffraction lattices or other suitable means are used that separate the scattered radiation wavelength-dispersively. The dispersed radiation is then detected by a location-sensitive detector depending on the wavelength. For angle-dependent detection of scattered radiation for determining the transmitted momenta, either the sample is tilted to vary the angle of incidence, or the spectrometer is panned around the sample. In the latter case, the sample must be a monocrystalline material.

If the incident beam is provided with a wavelength-dispersive element, the spectrometer also operates in wavelength-dispersive manner, and the scattered radiation is detected with a two-dimensional, position-sensitive detector as a function of the wavelength.

In addition, focusing elements may also be located in the beam path behind the sample.

The principles and experimental imperatives of RIXS are discussed comprehensively in the article by L. J. P. Ament et al., “Resonant inelastic X-ray scattering studies of elementary excitations” (Review of Modern Physics, Vol. 83, 2011, pp. 705-767). Two experimentation stations for soft and hard X-rays with equipment for conducting RIXS measurements are also explained in more detail. The described equipment for measuring with hard X-rays consists of a first double monochromator in the beam supplying part before the sample. This is followed by a quadruple monochromator to which are connected focusing mirrors that are arranged orthogonally to one another (cross-focusing Kirkpatrick-Baez geometry). A horizontal and vertical slit system and a chamber for on-line monitoring of the beam intensity are arranged farther along the beam path but before the sample. The spectrometer is placed on the “Rowland circle” and consists of a spherically curved analyser crystal, which reflects the scattered radiation dispersively onto a position-sensitive detector that is also disposed on the Rowland circle. Measurement is carried out sequentially, with the monochromators being tilted incrementally, resulting in a stepped change in the wavelength of the incident beam. The momentum space can also be measured incrementally at each step of the stepped change wavelength. The principle of the described apparatus is repeated at several experimentation stations of various synchrotron radiation sources.

Another device for RIXS measurements is described in the article by V. N. Strocov, “Concept of a spectrometer for resonant inelastic X-ray scattering with parallel detection in incoming and outgoing photon energies” (Journal of Synchrotron Radiation, Vol. 17, Book 1, 2010, pp. 103-106). This device is designed for use with soft X-rays radiation. A planar diffraction lattice is used as the monochromator, linearly dispersing the X-ray light in a wavelength range that is determined by the properties of the diffraction lattice, corresponding to a range from a few meV to eV. Farther along the beam path but before the sample, the X-ray light is focussed first vertically and then horizontally (cross-focusing Kirkpatrick-Baez geometry) and reflected on the sample as a vertical line focus. Behind the sample, the exiting radiation is focused vertically by a mirror and dispersed horizontally by a horizontally focusing diffraction lattice and reflected on a 2D area detector. That is to say, for each wavelength range incident on the sample, the associated scattered radiation is dispersed horizontally and the intensity distribution over the energy is reflected on the horizontal axis of the detector. The energy range of the monochromator is displayed on the vertical axis of the detector. Thus, a single exposure step (“one shot”) is sufficient to enable an RIXS measurement to be taken. An incremental, sequential tuning of wavelengths (energies) is not necessary. This enables the measuring time to be shorter than with the construction described previously.

The quality of the results achieved in a RIXS measurement depends substantially on the reflectivity of the mirrors used, the resolution capability of the monochromators and diffraction lattices, and their efficiency in diffracting the radiation. In general, each optical element in the beam path causes a loss of intensity.

In the article by A. Erko et al. “High-resolution diffraction X-ray optics” (Optics and Precision Engineering, Vol. 15, No. 12, 2007) “focusing reflection Bragg-Fresnel zone plates” are introduced. These consist of a reflector with elliptical, phase shifting Fresnel-type structures on the surface. Bragg mirrors or other multi-layer systems or a reflector having a highly polished surface, such as a silicon monocrystal, are suitable for use as a reflecting substrate. The Fresnel-type structures are embossed in the substrate surface with lithography and etching processes. Then, the plate is coated with gold. The elliptical Fresnel structures have a focusing effect in the sagittal and meridional planes. Properties such as energy (wavelength) of the diffracted radiation, glancing angle, exit angle and focal length are determined by the size and arrangement of the ellipses of the Fresnel-type structures. Accordingly, the reflection Bragg-Fresnel zone plates (reflection zone plates) serve as a monochromator for a wavelength that is determined by the Fresnel structure and which has a spectral width from a few meV to a few eV, which is also determined by the Fresnel structure. The wavelength distribution or energy distribution is reflected dispersively as a line focus. With reflection zone plates, the whole of the energy range that is of interest for RIXS measurements can be covered. Theoretically, reflection zone plates can be manufactured for energies of a few meV (THz radiation) up to several hundred keV, but they are subject to an upper design limit due to the available production methods.

An X-ray microscope for imaging surface topographies that is equipped with Fresnel zone lenses (FZL) is described in US 2008/0181363 A1. In this case, a FZL is positioned before the sample in the X-ray beam in transmission in order to focus it. The sample is positioned in the focus of this FZL with grazing incidence. A second FZL is used as the objective lens (in transmission) and is positioned in the beam reflected from the sample.

An application of reflection zone plates as described in the article by Erko et al. is disclosed in DE 10 2007 048 743 B4. The reflection zone plates are arranged in the beam in front of the sample to focus a specific wavelength range on a sample in dispersed manner for spectroscopic analyses. In this context, a plurality of reflection zone plates may be arranged side by side in front of the sample to cover a larger wavelength range.

A spectrograph consisting of one reflection zone plate that is designed for the VUV and soft X-ray range is described in DE 195 42 679 A1.

### SUMMARY

A device is for measuring resonant inelastic X-ray scattering of a sample with a single exposure step includes a first reflection zone plate configured to be irradiated first and foremost by an X-ray beam, a sample arranged at a focus of diffracted radiation from the first reflection zone plate, a second reflection zone plate arranged at a distance of its focal length from the sample; and a detector arranged at a focal plane of diffracted radiation of the second reflection zone plate, the detector being configured to perform spatially-resolved two-dimensional detection. The first and second reflection zone plates are arranged cross-dispersively. Respective wavelength ranges of the reflection zone plates are tuned to one another corresponding to an absorption edge of an element of the sample. The reflection zone plates are arranged such that parameters determined by selected orders of diffraction and one or more Fresnel structures, glancing angle, exit angle and focal length are fulfilled.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic representation of a reflection zone plate of the prior art; and

FIG. 2 is a schematic representation of the inventive solution with beam path.

### DETAILED DESCRIPTION

Starting from the disadvantages of the known prior art, an implementation of the present invention provides a device for measuring resonant inelastic X-ray scattering that is more time-economical and functions effectively with just one exposure step and fewer optical elements than devices of the prior art. The device according to the implementation of the present invention may also have high reflectivity and efficiency as well as good resolution, and it may be usable in both the soft and hard ranges of X-ray radiation.

The cross-dispersive arrangement of the reflection zone plates is characterized in that the dispersion directions of the reflection zone plates are oriented perpendicularly to each other. In this context, a first reflection zone plate is irradiated first and foremost by an incident beam. The sample is arranged in the focal plane of the radiation that is dispersed by the first reflection zone plate. The sample is also arranged in the focus of a second reflection zone plate, which disperses the radiation that is scattered by the specimen perpendicularly to the dispersion direction of the first reflection zone plate. In this way, the energy range dispersed vertically on the sample is dispersed horizontally behind the sample, so that the intensity distribution over the energy of the associated inelastically scattered radiation can be analysed for each energy with which the sample is irradiated. A means for spatially resolved detection in two dimensions is arranged in the focal plane of the radiation that is dispersed by the second reflection zone plate.

The first reflection zone plate is adjusted so that 0 order diffraction is suppressed and first order diffraction is used. For this purpose, the irradiated part of the reflection zone plate is shifted from the focus of the beam intersection points of 0 order diffraction, so that only parts of the Fresnel structure that are diffracted in the higher order are irradiated (‘off axis setting’). The sample is arranged in the focal plane of the first-order diffraction of the first reflection zone plate. The sample is also arranged in the focal plane of the first-order diffraction of the second reflection zone plate. The second reflection zone plate is irradiated in such manner that it diffracts in negative first order. The energy range of the diffracted radiation (negative first order) of the second reflection zone plate may be correspondingly smaller than that of the first reflection zone plate in order to be compensate for the expected loss of energy due to inelastic scattering. A common method for spatially resolved detection in two dimensions is provided behind the second reflection zone plate in the focal plane of radiation diffracted to the negative first order by the second reflection zone plate.

A subassembly consisting of the second reflection zone plate and the detector is freely positionable on a circular path, the focal point of which is the position of the sample and of which the radius is defined by the focal point of the second reflection zone plate, with the exception of the range of radiation incident on the sample. In the case that the sample is a monocrystal, the change of momentum of the scattered radiation can be measured by pivoting the sub-assembly on the circular path, or by tilting the sample.

The angle between the incident beam and the plane of the first reflection zone plate corresponds to the glancing angle, which is determined by the Fresnel structures. The second reflection zone plate is positioned in such manner that the angle between the plane thereof and the distance |Sample—Focal centre second reflection zone plate| corresponds to the glancing angle thereof.

The distance |First reflection zone plate—Sample| is determined by the focal length of the diffraction of first order of the first reflection zone plate. The distance |Sample—Second reflection zone plate) is determined by the focal length of the diffraction of first order of the second reflection zone plate. The distance |Second reflection zone plate—Detector| is determined by the focal length of the negative first order diffraction of the second reflection zone plate.

Energy resolutions E/AE of up to about 40,000 can be achieved by adjusting the first and second reflection zone plates, depending on the manufacturing process used for the plates.

In one embodiment of the invention, a means for monitoring beam intensity and energy distribution that detects radiation of higher order (>±1) diffracted at the first reflection zone plate is provided in the beam path in front of the sample.

In a further embodiment of the invention, means are provided for accommodating a plurality of first and second reflective zone plates each with different Fresnel-type structures, which ensure automatic switching of the reflection zone plates according to the need for a particular wavelength.

In a further embodiment, the bremsstrahlung of the primary beam is absorbed in the beam path before or after the first reflection zone plate by a radiation shielding means arranged there.

In another embodiment, a means is provided for evacuating the beam path from the first reflection zone plate as far as the detector, in order to minimise intensity losses during measurements in the soft radiation range.

Advantages of the invention can include the use of a low number of optical elements (minimum two), the capability of use in a wide energy range from soft to hard X-ray radiation, and very good energy resolution and shortened measuring time due to the non-sequential measuring method with a single exposure step.

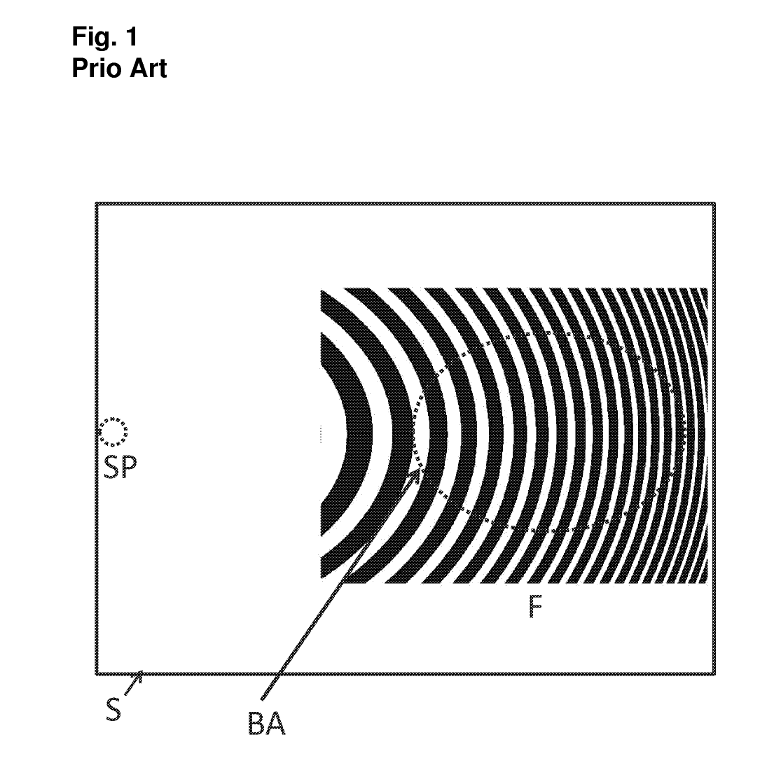

The schema shown in FIG. 1 of a reflection zone plate corresponds to the reflections zone plates such as are used in the embodiment and are known from the prior art. The reflection zone plate is formed from a silicon monocrystal substrate (silicon wafer) S, on which the Fresnel-type structures F are applied by electron beam lithography. The Fresnel structures F have dimensions of 12 nm×50 nm. The surface of the plate consists of a 45 nm layer of gold. The figure also shows the focus of the beam intersection points of the 0 order diffraction SP. This is intended to illustrate the “off axis setting” described above together with the location of the surface BA irradiated for diffraction of the first order.

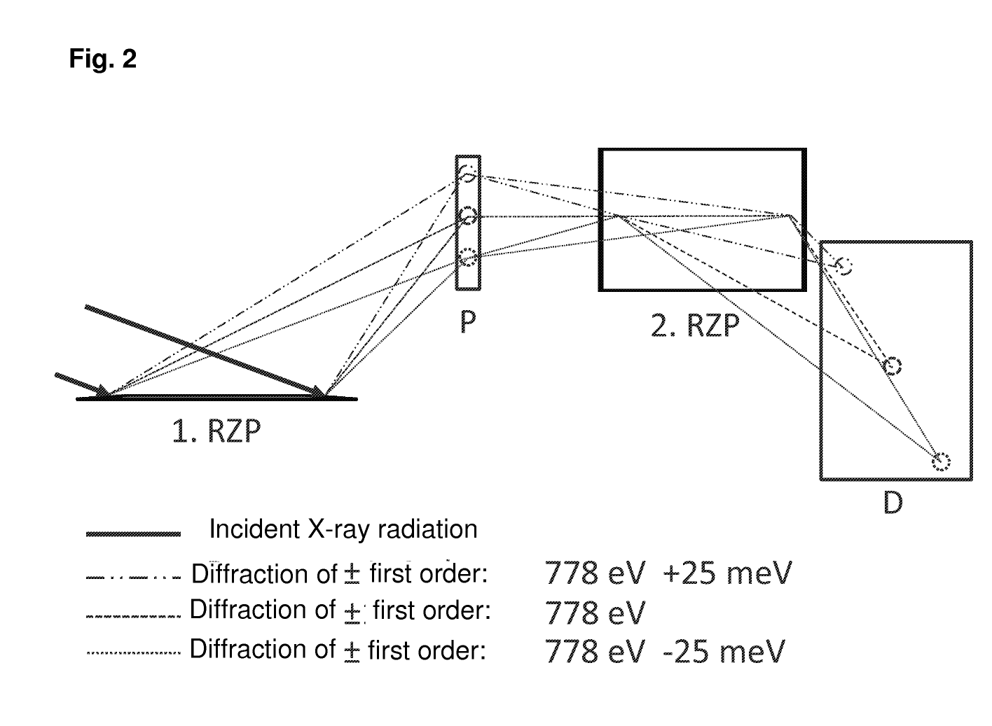

In FIG. 2, the device for measuring resonant inelastic X-ray scattering of a sample P is shown with the beam path. The incident X-ray radiation is characterized by solid lines, the rays of the diffraction of first order of the first reflection zone plate 1.RZP at 778 eV is dashed, the diffraction of first order +25 meV is indicated with a dash-dotted line, and the diffraction of first order −25 meV is dotted. The beam paths shown serve to illustrate the dispersive effect of the reflection zone plates, which is actually continuous. The first reflection zone plate 1.RZP is oriented horizontally such that the angle of incidence of the X-ray beam on the surface of the reflection zone plate is 2°, which corresponds to the Bragg angle of reflection zone plate 1.RZP. The Fresnel-type structures on the surface cause a diffraction of the 1st order at an energy level of 778 eV±25 meV. This corresponds to an RIXS measurement on the Co-L3 edge. The exit angle of the diffracted radiation is 3.8° with respect to the plane of first reflection zone plate 1.RZP. The dispersion direction thereof is vertical. The line focus of first reflection zone plate 1.RZP is reflected onto sample P in the plane of its focus. Second reflection zone plate 2.RZP is located in the beam path behind sample P and is identical to the first in terms of its structure and causes a negative first order diffraction −1 for the same energy, that is to say 778 eV±25 meV. The path (Sample P—Second reflection zone plate 2.RZP1 forms an angle of 5° with the surface of second reflection zone plate 2.RZP. The dispersion direction of the second reflection zone plate 2.RZP is oriented horizontally and perpendicularly to first reflection zone plate 1.RZP. The radiation diffracted at an angle of 2° relative to the plane of second reflection zone plate 2.RZP is detected by a CCD camera D with pixel sizes from 13 μm×13 μm.

The distances in this structure are as follows; from first reflection zone plate 1.RZP to sample P, 0.35 m; from sample P to the second reflection zone plate 2.RZP, 2 m; from the second reflection zone plate 2.RZP to detector D, 5 m.

The energy resolution E/ΔE at detector D is 31,000 and the efficiency of the two reflection zone plates 1.RZP and 2.RZP combined is 0.15², which corresponds to a reflectivity of a single reflection zone plate of 15%. The exposure time, which corresponds to the measurement period, is dependent on the intensity of the incident radiation and may vary from the femtosecond range up to several minutes.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1-5. (canceled)

6. A device for measuring resonant inelastic X-ray scattering of a sample with a single exposure step, the device comprising:
a first reflection zone plate configured to be irradiated first and foremost by an X-ray beam;
a sample arranged at a focus of diffracted radiation from the first reflection zone plate;
a second reflection zone plate arranged at a distance of its focal length from the sample; and
a detector arranged at a focal plane of diffracted radiation of the second reflection zone plate, the detector being configured to perform spatially-resolved two-dimensional detection;
wherein the first and second reflection zone plates are arranged cross-dispersively,
wherein respective wavelength ranges of the reflection zone plates are tuned to one another corresponding to an absorption edge of an element of the sample, and
wherein the reflection zone plates are arranged such that parameters determined by selected orders of diffraction and one or more Fresnel structures, glancing angle, exit angle and focal length are fulfilled.

7. The device according to claim 6, further comprising a monitor, arranged below an angle of at least one of a second or higher order of positive or negative diffraction of the first reflection zone plate, the monitor being configured to perform direct monitoring of beam intensity and energy distribution of the X-ray beam.

8. The device according to claim 6, wherein a plurality of reflection zone plates having different wavelength ranges are replaceably arrangeable at locations of the first and second reflection zone plates.

9. The device according to claim 6, further comprising a bremsstrahlung absorber positioned in a beam path of the x-ray beam in front of or behind the first reflection zone plate, the bremsstrahlung absorber being configured to absorb the bremsstrahlung from the X-ray beam.

10. The device according to claim 6, wherein the device is configured to be evacuated from the first reflection zone plate to the detector.
